(19) United States
(12) Patent Application Publication
(10) Pub. No.: US 2008/0005109 A1
(43) Pub. Date: Jan. 3, 2008

(54) One Click View Arrangement

(75) Inventors: Donna B. Andrews, Shoreline, WA (US); David G. De Vorchik, Seattle, WA (US); Kenneth M. Tubbs, Issaquah, WA (US); Paul A. Gusmorino, Seattle, WA (US); Cornelis K. van Dok, Tubingen (DE)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/428,180

(22) Filed: Jun. 30, 2006

(51) Int. Cl. G06F 17/30

(52) U.S. Cl. 707/7

(57) ABSTRACT

The present example provides a method of displaying by a single click, a view arrangement that may include data displayed by a sorting by a name process, a grouping by a type process, and a stacking by a keywords process.

### TECHNICAL FIELD

This description relates generally to arranging data and more specifically to arranging data by properties.

### BACKGROUND

Personal computers may often display large amounts of information. A typical challenge is to present information stored on a computer in a user friendly format that allows a user to sort and view the data in an understandable and useful way. For example, hundreds of files may show up in a single view or window showing the contents of a directory or disk. Typical ways that an operating system can allow arrangement may include choosing a property to sort by, that is presented in a submenu in a toolbar of a window produced by the OS.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a method of displaying by a single click, a view arrangement that may include data displayed by a sorting by a name process, a grouping by a type process, and a stacking by a keywords process.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a network diagram of a conventional computer network including a typical OS having a typical view arrangement method running on a client computer.

FIG. 2 is a network diagram of a computer network including an OS with a one click view arrangement method running on a client computer.

FIG. 3 is a series of client computer displays showing data arranged by NAME, TYPE, and KEYWORDS, that were generated by the one click view arrangement method.

FIG. 4 is a flow chart of a process of displaying data arranged by NAME.

FIG. 5 is a flow chart of a process of displaying data arranged by TYPE.

FIG. 6 is a flow chart of a process of displaying data arranged by KEYWORDS.

FIG. 7 is a flow chart of the process of displaying data arranged by NAME, TYPE, KEYWORDS, and DATE CREATED as generated by a one click view arrangement method.

FIG. 8 is a display of typical data not arranged by any data properties that may be displayed prior to arrangement by a one click view attempt.

FIG. 9 is a display of data stacked by KEYWORDS generated by the one click view arrangement method.

FIG. 10 is a display of data stacked by KEYWORDS, then grouped by TYPE generated by the one click view arrangement.

FIG. 11 is a display of data stacked by KEYWORDS, then grouped by TYPE, then sorted by DATE CREATED generated by the one click view arrangement.

FIG. 12 is a display of data stacked by KEYWORDS, then grouped by TYPE, then sorted by DATE CREATED, then sorted by NAME generated by the one click view arrangement method.

FIG. 13 is diagram of a computer that may process the one click view arrangement method to generate the previously described displays.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a one click view arrangement method for displaying data. Although the present examples are described and illustrated herein as being implemented in an application or file explorer system, the system described is provided as an example and not a limitation. As those skilled in the art will appreciate, the present examples are suitable for application in a variety of different types of data display systems, such as an operating system (“OS”) or other equivalent application programs (“applications”).

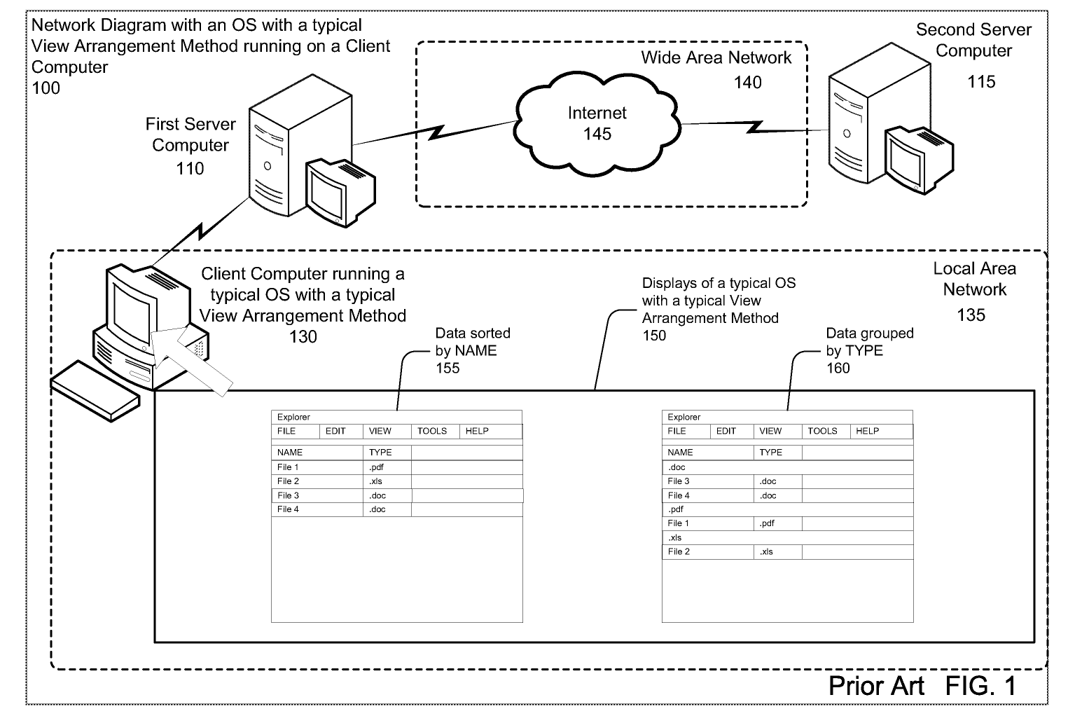

FIG. 1 is a network diagram showing a conventional system 100 including a client computer running a typical OS having a typical view arrangement method. The typical application or OS with a typical view arrangement method is usually disposed on a conventional PC, client computer or equivalent 130. The conventional client computer 130 may be coupled via a conventionally constructed local area network 135 to a conventional first server computer 110. The first server computer 110 may be coupled to a conventional wide area network 140, which may include a conventional Internet connection 145 to a conventional second server computer 115.

The local area network 135 may include a conventionally constructed ISP network in which a number, or plurality, of subscribers may utilize telephone dial up, ISDN, DSL, cellular telephone, cable modem, or similar connections to couple their computer to one or more server computers 115 that may provide a connection to the World Wide Web 140 via the Internet 145.

The wide area network or World Wide Web 140 is conventionally constructed and may include the Internet 145 or equivalent structure for providing a wide area network. The wide area network may couple to any number of computers through any number of wide area and local area connections.

The computing device running the typical OS with the typical view arrangement method 130 may by any conventional operating system. The computing device running the typical OS with the typical view arrangement method 130 may produce a variety of displays 150 that may include arranged data 155,160. Such displays are typically produced by a multi-step or multi-click process that may involve accessing one or more menus or sub menus to produce the displays shown. For example the user may have to access the Main Menu, then click on VIEW, then click on Arrange By, and then select the data property to sort by or select Show in Groups to group data by the selected data property. Display 155 shows data sorted by the data property of NAME. Display 160 shows data grouped by TYPE.

The exemplary data sorted by NAME display 155 is an illustration of what a user would typically see on a computer screen when using an OS to arrange data by data properties, in particular sorting by NAME. When the user accesses data to display that is arranged by default settings or is not arranged, the user is able to change the display of the data by arranging the data by data properties. Thus, the user may choose to arrange the data by sorting by NAME 155.

The exemplary data grouped by TYPE display 160 is an illustration of what a user would see on a computer screen when using an OS to arrange data by data properties, in particular grouping by TYPE. When the user accesses data to display that is arranged by default settings or is not arranged, the user is able to change the display of the data by arranging the data by data properties. Thus, the user may choose to arrange the data by grouping by TYPE 160. In the following paragraphs a method of producing displayed data by a one click view arrangement will be described. In these figures like valued items will be understood to refer to like elements previously described and will thus need not be described again.

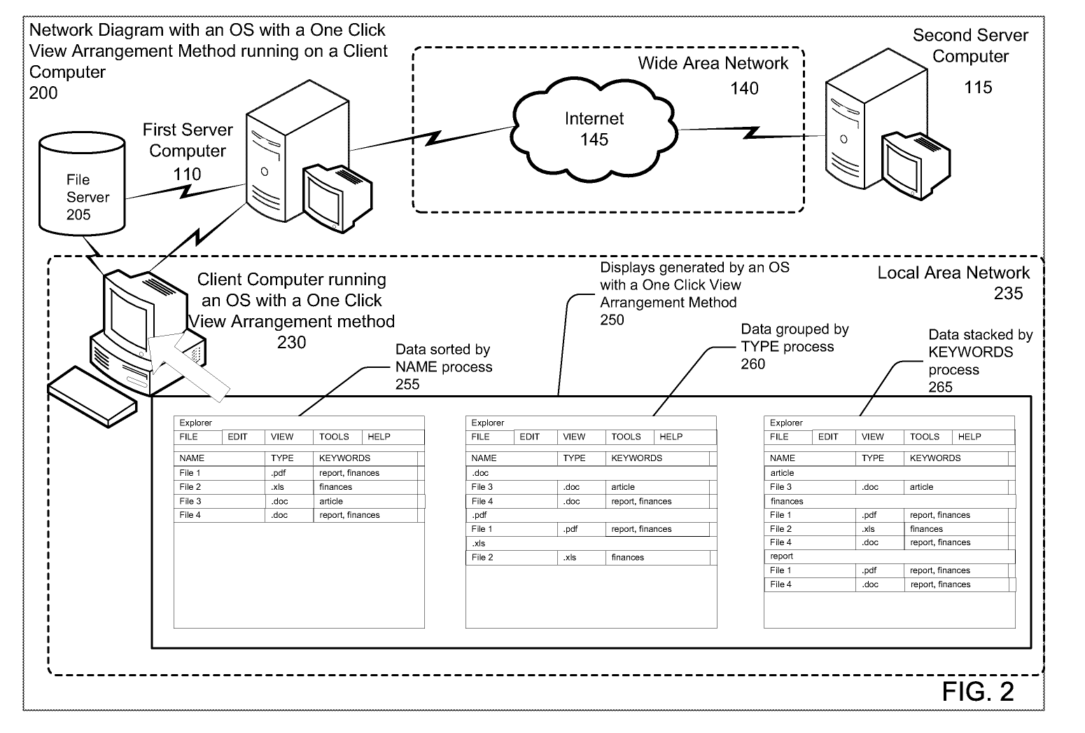

FIG. 2 is a network diagram of a computer network 200 including an OS with a one click view arrangement method running on a client computer. The OS or application with a one click view arrangement method is usually disposed on a PC, client computer or equivalent 230. The client computer 230 may also be a file server or may contain a repository of files and documents. The client computer 230 may be coupled via a local area network 235 to a first computer server 110 and/or a file server 205. The first server computer 110 may be coupled to the file server 205 and/or a wide area network 140, which may include an Internet connection 145 to a second server computer 115. The file server 205 may be a number of local area networks, a wide area network or an equivalent structure containing data.

The local area network 235 may include a constructed ISP network in which a number, or plurality, of subscribers may utilize telephone dial up, ISDN, DSL, cellular telephone, cable modem, or similar connections to couple their computer to one or more server computers 115 that may provide a connection to the World Wide Web 140 via the Internet 145.

The computing device running the OS with the one click view arrangement method 230 may produce a variety of displays 250 that may include arranged data 255, 260, and 265. Such displays are produced by a single click process. Display 255 shows data sorted by the data property of NAME. Display 260 shows data grouped by the data property TYPE. Display 265 shows data stacked by the data property KEYWORDS.

The exemplary data sorted by NAME display 255 is an illustration of what a user would see on a computer screen when using an OS with a one click view arrangement method to arrange data by data properties, in particular by performing a single click on the NAME column header to sort the data by NAME. When the user first accesses the data to display, the data may be arranged by default settings or may not be arranged. The user is able to change the display of the data by arranging the data by NAME by performing a single click on the NAME column header 255.

The exemplary data grouped by TYPE display 260 is an illustration of what a user would see on a computer screen when using an OS with a one click view arrangement method to arrange data by data properties, in particular by performing a single click on the TYPE column header to group the data by TYPE. When the user first accesses the data to display, the data may be arranged by default settings or may not be arranged. The user is able to change the display of the data by arranging the data by TYPE by performing a single click on the TYPE column header 260.

The exemplary data stacked by KEYWORDS display 265 is an illustration of what a user would see on a computer screen when using an OS with a one click view arrangement method to arrange data by data properties, in particular by performing a single click on the KEYWORDS column header to stack the data by KEYWORDS. When the user first accesses the data to display, the data may be arranged by default settings or may not be arranged. The user is able to change the display of the data by arranging the data by KEYWORDS by performing a single click on the KEYWORDS column header 265.

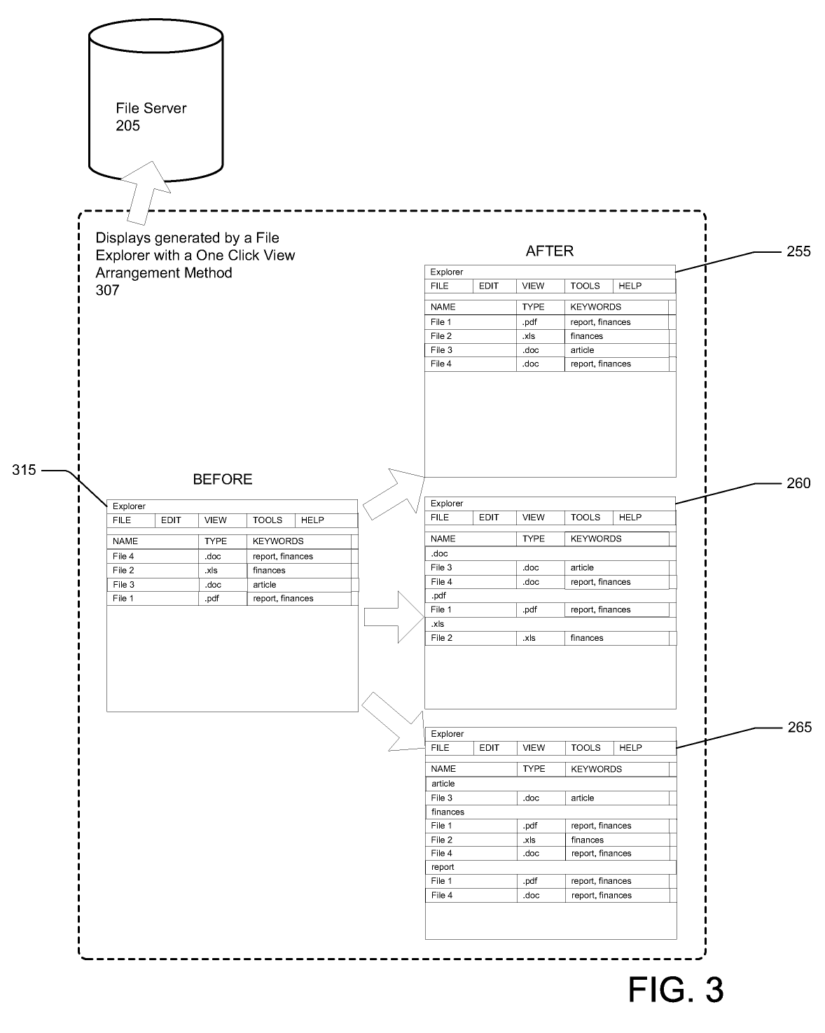

FIG. 3 is a series of client computer displays 307 showing data arranged by NAME 255, TYPE 260, and KEYWORDS 265, which were generated by the one click view arrangement method. The file explorer displays 255, 260, 265 may be displayed from time to time when a user chooses to arrange data 315 using desired data properties. The data arranged may exist on a file server 205 or an equivalent structure containing data. The file server may be a number of local area networks 235 or a wide area network 140. A file explorer may have access to the file server 205 through the World Wide Web 145, a local area network 235, or the like. The displayed data from the file server 205 may be arranged by default settings or not arranged 315 when it is initially presented.

The user may choose to display the data 315 by sorting the data by NAME using the one click view arrangement method 255. Each of the data properties may have a default arrangement mode and arrangement order. The default arrangement mode for NAME may be sort and the default arrangement order may be ascending. The user performs a single click on the NAME column header and the default settings for the data property NAME are applied to the display of the data.

The user may choose to display the data 315 by grouping the data by TYPE using the one click view arrangement method 260. The default arrangement mode for TYPE may be group and the default arrangement order may be ascending.

The user may choose to display the data 315 by stacking the data by KEYWORDS using the one click view arrangement method 265. The default arrangement mode for KEYWORDS may be stack and the default arrangement order may be ascending.

The default arrangement mode and arrangement order of all data properties may be changed by the user at any time. When a user changes the default arrangement mode and/or arrangement order of a data property, the one click view arrangement method may apply these changes to the display of data when the user chooses to display data by the customized data property. This may be applied locally to a specific folder or may be applied globally to all folders.

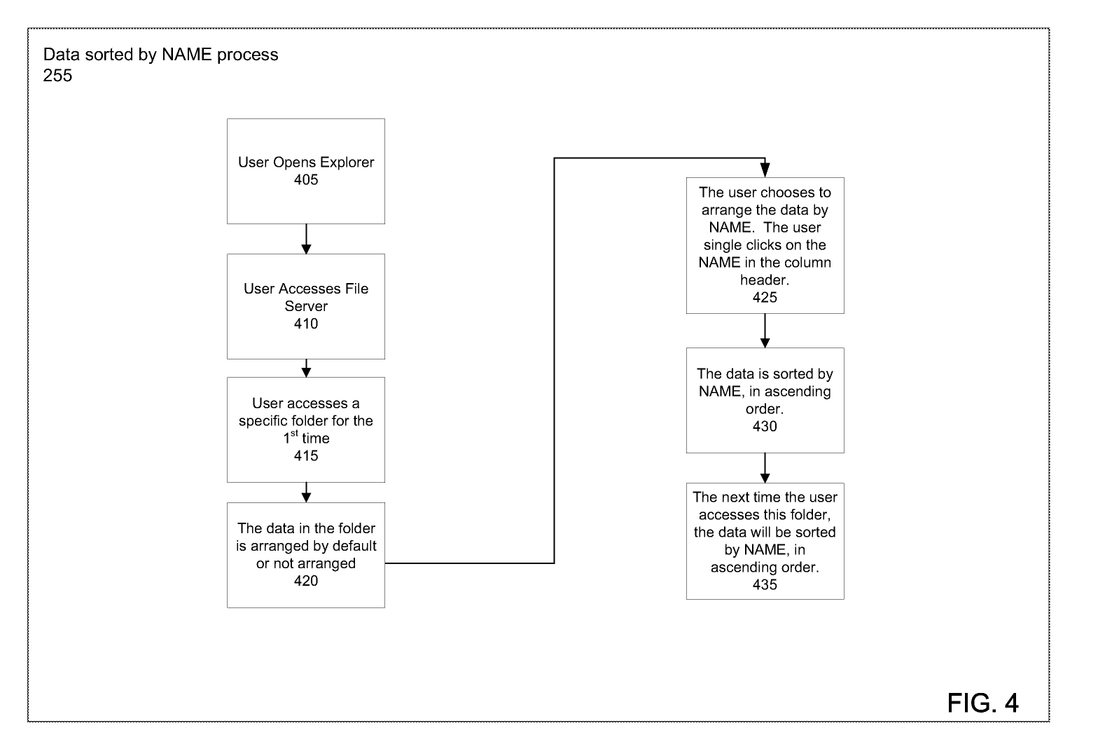

FIG. 4 is a flow chart of a process of displaying data arranged by NAME 255. A user may open a file explorer, OS, application, or their equivalent 405 and access a file server or equivalent repository of files or documents 410. The user may access a folder for the first time 415 on the file server and display data contained in the folder. The displayed data may be arranged by default settings or not arranged 420.

The user may then choose to arrange the data by NAME by performing a single click on the NAME column header 425 or the equivalent container of a data property. The one click view arrangement method sorts the data by NAME in ascending or other derived order 430. The data is sorted and arranged in ascending order because these are the default settings for the data property NAME. These default settings can be changed by the user. When the user accesses this particular folder in the future, the display of the data will be arranged by sorting by NAME in ascending 435. Those skilled in the art may refer to this feature as persistence.

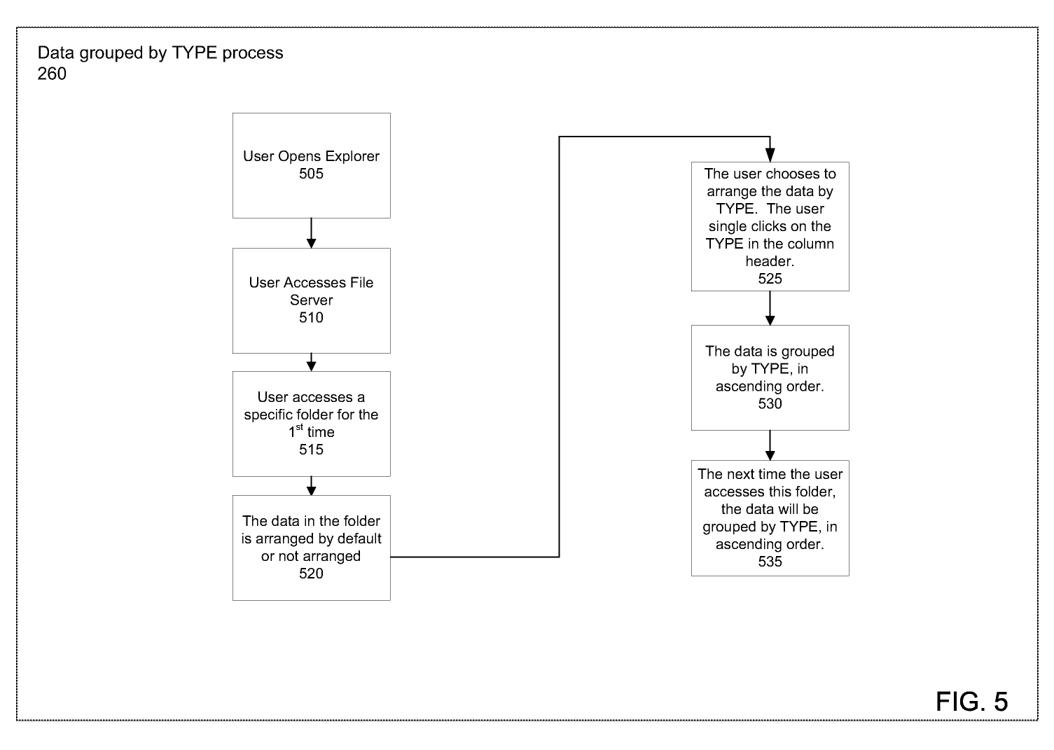

FIG. 5 is a flow chart of a process of displaying data arranged by TYPE 260. A user may open a file explorer, OS, application, or their equivalent 505 and access a file server or equivalent repository of files or documents 510. The user may access a folder for the first time 515 on the file server and display data contained in the folder. The displayed data may be arranged by default settings or not arranged 520.

The user may then choose to arrange the data by TYPE by performing a single click on the TYPE column header 525 or the equivalent container of a data property. The one click view arrangement method groups the data by TYPE in ascending or other derived order 530. The data is grouped and arranged in ascending order because these are the default settings for the data property TYPE. These default settings can be changed by the user. When the user accesses this particular folder in the future, the display of the data will be arranged by grouping by TYPE in ascending 535. Those skilled in the art may refer to this feature as persistence.

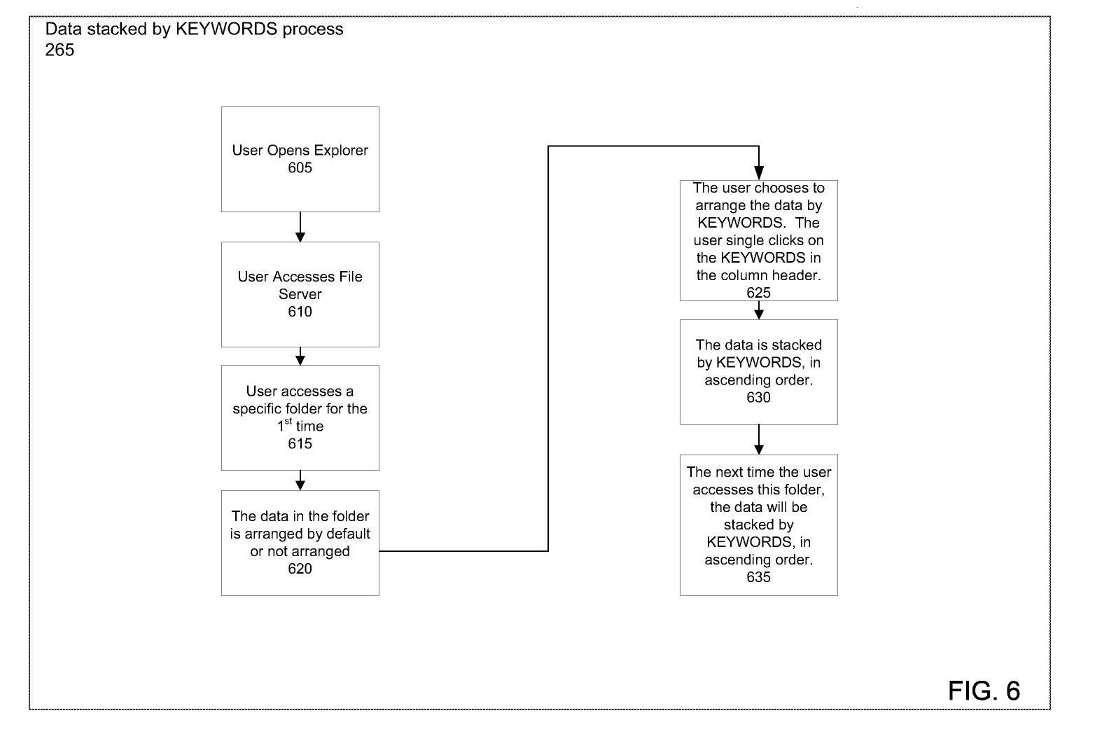

FIG. 6 is a flow chart of a process of displaying data arranged by KEYWORDS 265. A user may open a file explorer, OS, application, or their equivalent 605 and access a file server or equivalent repository of files or documents 610. The user may access a folder for the first time 615 on the file server and display data contained in the folder. The displayed data may be arranged by default settings or not arranged 620.

The user may then choose to arrange the data by KEYWORDS by performing a single click on the KEYWORDS column header 625 or the equivalent container of a data property. The one click view arrangement method stacks the data by KEYWORDS in ascending or other derived order 630. The data is stacked and arranged in ascending order because these are the default settings for the data property KEYWORDS. These default settings can be changed by the user. When the user accesses this particular folder in the future, the display of the data will be arranged by stacking by KEYWORDS in ascending 635. Those skilled in the art may refer to this feature as persistence.

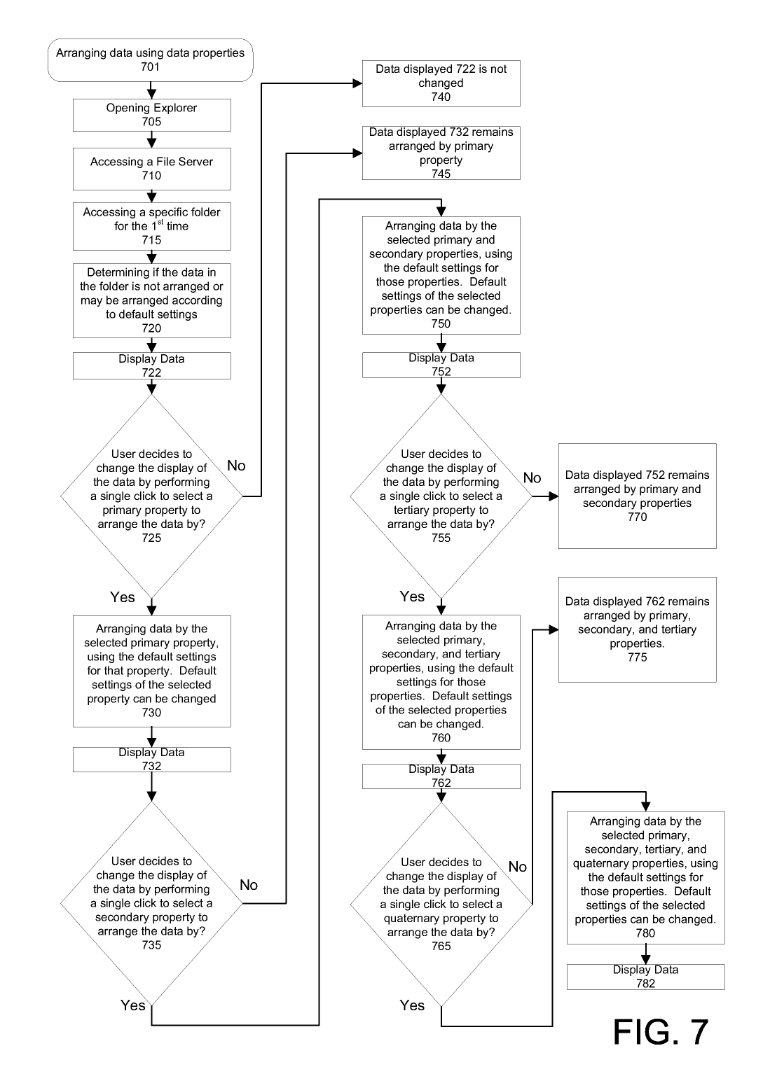

FIG. 7 is a flow chart of the process of displaying data arranged by NAME, TYPE, KEYWORDS, and DATE CREATED 701 as generated by a one click view arrangement method. This method may incorporate previously shown three methods into an overall process for creating displays of data. A user may open a file explorer, OS, application or their equivalent 705 that may access a file server or equivalent repository of files or documents 710. The user may access a specific folder for the first time 715 on the file server. The file explorer may determine if the data in the folder is arranged by default settings, or not arranged 720 and display the data 722.

The user may decide to change the display of the data by performing a single click to select a primary data property to arrange the data by 725. The one click view arrangement method may arrange the data by the selected primary data property using the default settings for the selected data property 730 and then display the data 732. The default settings for the data property may be changed by the user at any time.

The user may decide to further arrange the data by performing a single click to select a secondary data property 735 using the default settings of the selected secondary data property to arrange the data by 750 and then display the data 752. The one click view arrangement method may use the secondary data property to further arrange the previously displayed data 732. Arranging by a secondary data property is a subservient action to arranging the data by the primary data property. The default settings of the secondary data property may be changed by the user at any time.

The user may decide to further arrange the data by performing a single click to select a data property 755 using the default settings of the selected tertiary data property to arrange the data by 760 and then display the data 762. The one click view arrangement method may apply the tertiary data property to further arrange the previously displayed data 752. Arranging by a tertiary data property is a subservient action to arranging the data by the primary and secondary data properties. The default settings of the tertiary data property may be changed by the user.

The user may decide to further arrange the data by performing a single click to select a data property 765 using the default settings of the selected quaternary data property to arrange the data by 780 and then display the data 782. The one click view arrangement method may apply the quaternary data property to further arrange the previously displayed data 762. Arranging by a quaternary data property is a subservient action to arranging the data by the primary, secondary, and tertiary data properties. The default settings of the quaternary data property may be changed by the user.

Returning to 725, the user may decide not to arrange the data 740 and continue to display the data with default settings or not arranged 722.

Returning to 735, the user may decide not to arrange the data by a secondary data property and display the data arranged by the primary property 745.

Returning to 755, the user may decide not to arrange the data by a tertiary data property and display the data arranged by the primary and secondary properties 770.

Returning to 765, the user may decide not to arrange the data by a quaternary data property and display the data arranged by the primary, secondary, and tertiary properties 775.

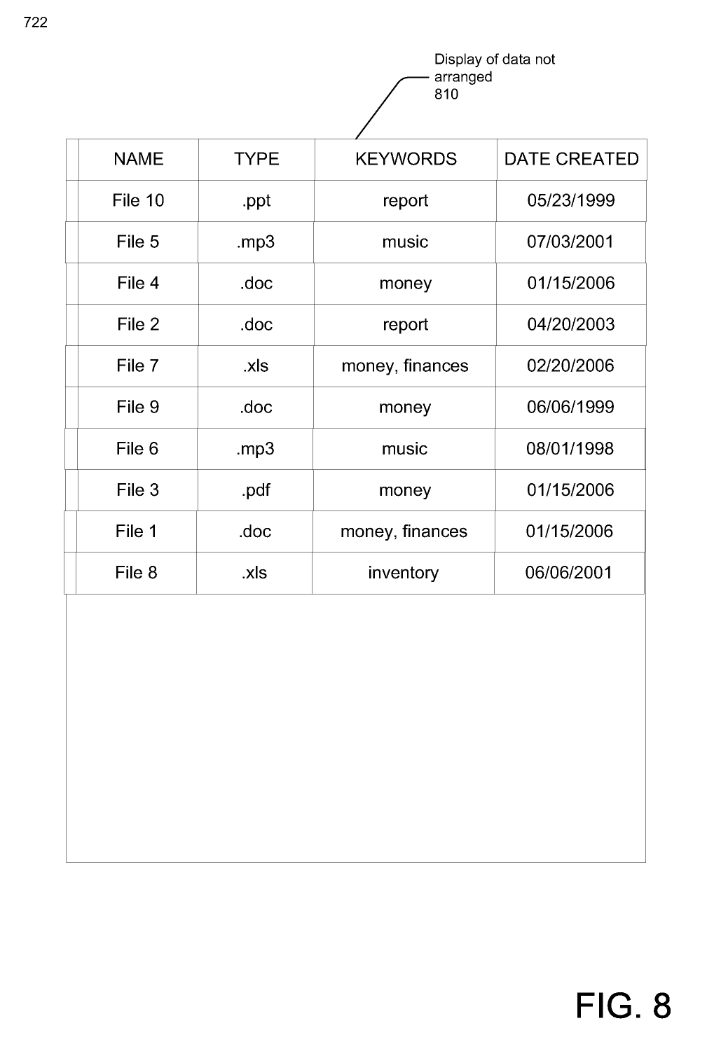

FIG. 8 is a display of typical data not arranged by any data properties that may be displayed prior to arrangement by a one click view attempt 810. The data displayed contains data properties NAME, TYPE, KEYWORDS, and DATE CREATED. The display of data 810 is not arranged by any of these data properties and is an exemplary display of what may be presented as display 722 as described above in FIG. 7, when a user first accesses a specific folder on a file server or equivalent repository of files or documents.

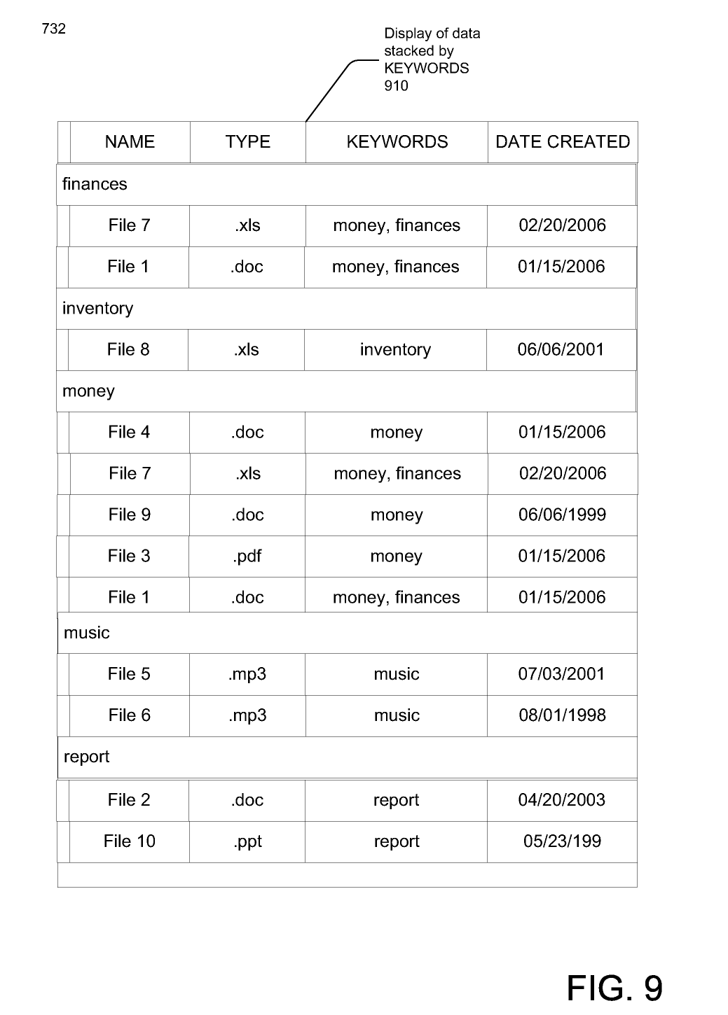

FIG. 9 is a display of data stacked by KEYWORDS generated by the one click view arrangement method 910. The data displayed contains data properties NAME, TYPE, KEYWORDS, and DATE CREATED. The display of data 910 is stacked by KEYWORDS and is an exemplary display of what may be presented as display 732 as described above in FIG. 7, when a user may select KEYWORDS as a primary data property to arrange the data by.

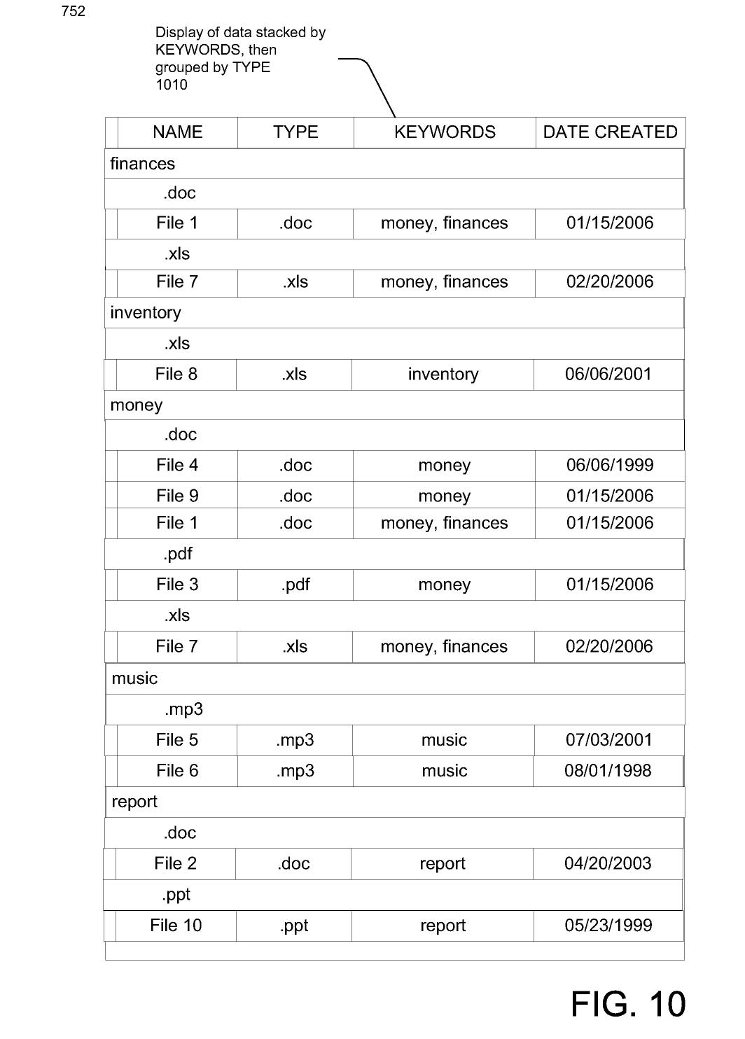

FIG. 10 is a display of data stacked by KEYWORDS and then grouped by TYPE, generated by the one click view arrangement method 1010. The data displayed contains data properties NAME, TYPE, KEYWORDS, and DATE CREATED. The display of data 1010 is stacked by KEYWORDS and then grouped by TYPE, and is an exemplary display of what may be presented as display 752 as described above in FIG. 7, when a user may select KEYWORDS as a primary data property and then select TYPE as a secondary data property, to arrange the data by.

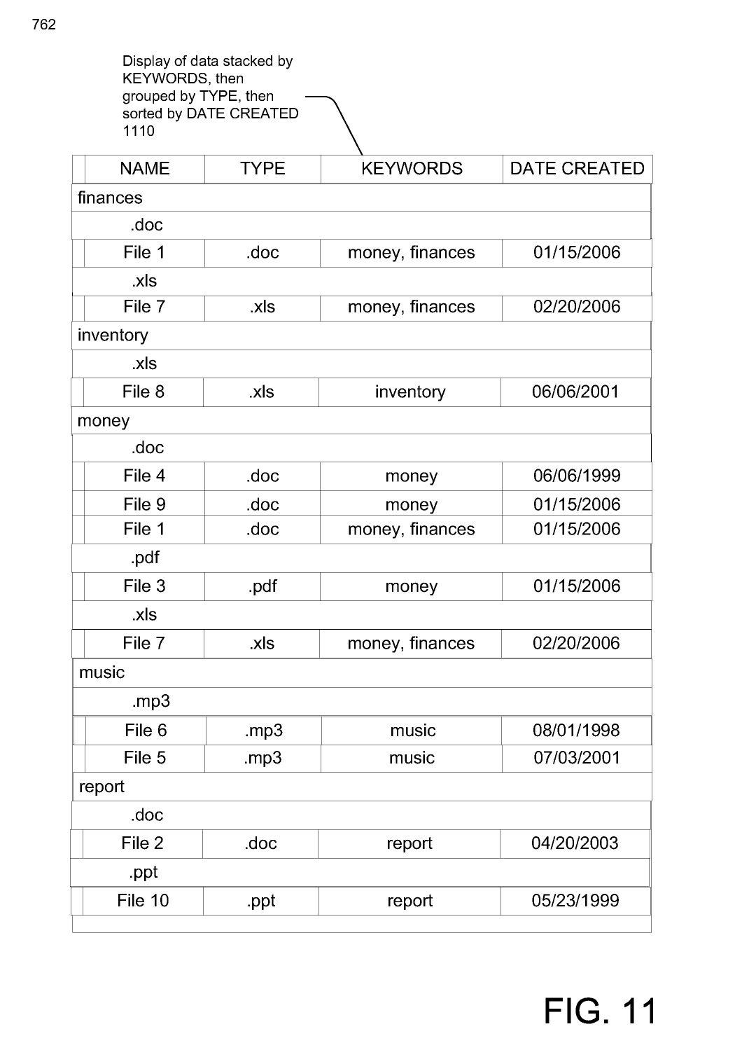

FIG. 11 is a display of data stacked by KEYWORDS, then grouped by TYPE, and then sorted by DATE CREATED, generated by the one click view arrangement method 1110. The data displayed contains data properties NAME, TYPE, KEYWORDS, and DATE CREATED. The display of data 1110 is stacked by KEYWORDS, then grouped by TYPE, and then sorted by DATE CREATED, and is an exemplary display of what may be presented as display 762 as described above in FIG. 7, when a user may select KEYWORDS as a primary data property, then select TYPE as a secondary data property, and then select DATE CREATED as the tertiary data property, to arrange the data by.

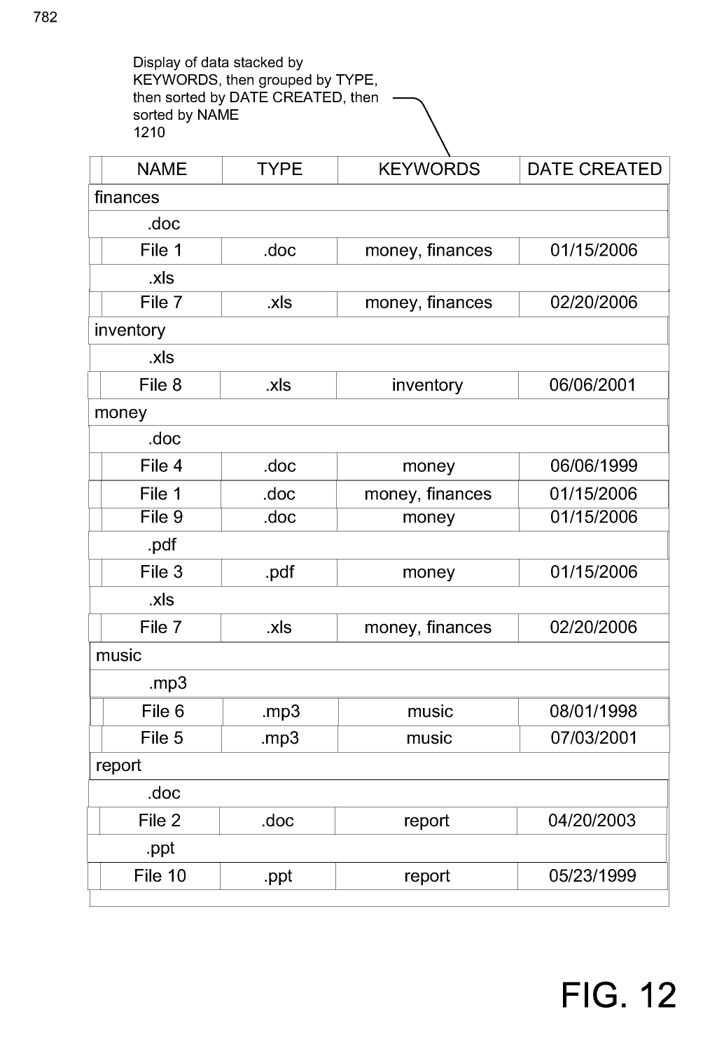

FIG. 12 is a display of data stacked by KEYWORDS, then grouped by TYPE, then sorted by DATE CREATED, and then sorted by NAME generated by the one click view arrangement method 1210. The data displayed contains data properties NAME, TYPE, KEYWORDS, and DATE CREATED. The display of data 1210 is stacked by KEYWORDS, then grouped by TYPE, then sorted by DATE CREATED, and then sorted by NAME, and is an exemplary display of what may be presented as display 782 as described above in FIG. 7, when a user may select KEYWORDS as a primary data property, then select TYPE as a secondary data property, then select DATE CREATED as the tertiary data property, and then select NAME as the quaternary data property, to arrange the data by.

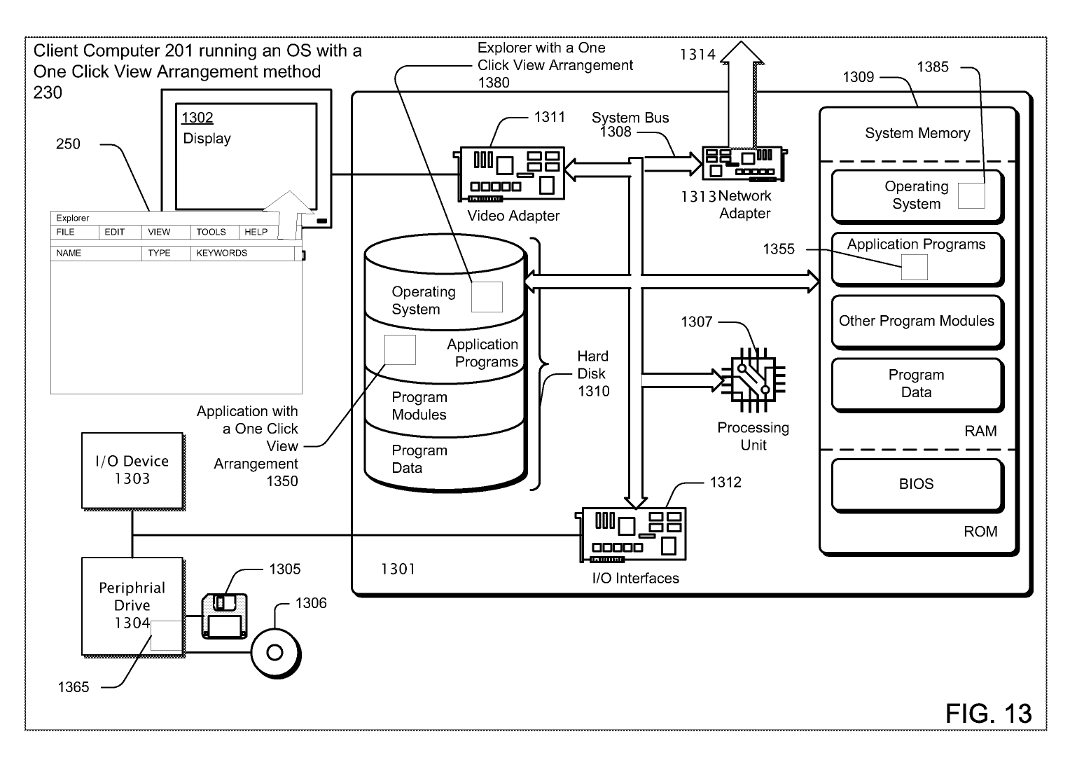

FIG. 13 is a diagram of an exemplary computer environment 230 that may provide processing for the one click view arrangement method described in this application. Exemplary computing environment 230 is only one example of a computing system and is not intended to limit the examples described in this application to this particular computing environment. The one click view arrangement method may be loaded onto the computer 230 through the use of computer readable media 1305,1306, or over a network 1314. Once loaded onto the computer 230 the method may reside as part of an application program 1350 on an internal hard drive 1310. When processing, the method may also exist as part of an application program 1355 loaded into system memory 1309.

For example the computer 230 can be implemented with numerous other general purpose or special purpose computing systems configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 230 includes a general-purpose computing system in the form of a computing device 1301. The components of computing device 1301 can include one or more processors (including CPUs, GPUs, microprocessors, and the like) 1307, a system memory 1309, a system bus 1308 that couples the various system components, and the method described above. Processor 1307 processes various computer executable instructions, including those to execute and run the one click view arrangement method 250 to control the operation of computing device 1301 and to communicate with other electronic and computing devices (not shown). The system bus 1308 represents any number of several types of bus structures, including a memory bus or memory controllers, a peripheral bus, an accelerated graphics port, and a processor or local bus using any of a variety of bus architectures.

The system memory 1309 may include computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one ore more of the processors 1307. The one click view arrangement method may be stored in RAM as part of an application program 1355 or as a component of an operating system 1385 and may be accessible to and/or presently operated on by one or more of the processors 1307.

Mass storage devices 1304 may be coupled to the computing device 1301 or incorporated into the computing device by coupling to the bus. Such mass storage devices 1304 may include a magnetic disk drive which reads from and writes to a removable, non-volatile magnetic disk (e.g., a “floppy disk”) 1305, or an optical disk drive that reads from and/or writes to a removable, non-volatile optical disk such as a CD-ROM or the like 1306. Computer readable media such as 1305,1306 typically embody computer readable instructions, data structures, program modules and the like supplied on floppy disks, CDs, portable memory sticks and the like. The one click view arrangement method 1365may be provided to the CPU 1301 by the peripheral device 1304. The one click view arrangement method previously described may be disposed on these computer readable media.

Any number of program modules can be stored on the hard disk 1310, Mass storage devices 1304, ROM and/or RAM 1309, including by way of example, an operating system, one or more application programs other program modules, and program data. The one click view arrangement method 1350 may be stored on the hard disk 1310 or made available through a peripheral drive 1304. Each of such operating system, application programs, other program modules and program data (or some combination thereof) may include an embodiment of the systems and methods described herein.

A display device 1302 can be connected to the system bus 1308 via an interface, such as a video adapter 1311. The display device 1302 displays the one click view arrangement method 250 to the user. A user can interface with the computer device 1302 via any number of different input devices 1303 such as a keyboard, pointing device, joystick, game pad, serial port, and/or the like. These and other input devices are connected to the processors 1307 via input/output interfaces 1312 that are coupled to the system bus 1308 but may be connected by other interface and bus structures, such as a parallel port, game port, and/or a universal serial bus (USB).

Computing device 230 can operate in a networked environment using connections to one or more remote computers through one ore more local area networks (LANs), wide area networks (WANs), and the like.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for arranging and displaying data comprising:
accessing data or data attributes;
determining if the data is arranged by default settings or not arranged;
displaying the data;
providing a one-click view arrangement for sorting the data, grouping the data, and stacking the data; and
displaying the data.
